(19) United States
(12) Patent Application Publication
(10) Pub. No.: US 2026/0088579 A1
(43) Pub. Date: Mar. 26, 2026

(54) TRACK AND RELATED PLUG-IN ADAPTER, IN PARTICULAR FOR LIGHTING SYSTEMS

(71) Applicant: IGUZZINI ILLUMINAZIONE S.P.A., Recanati (IT)

(72) Inventor: Massimo GATTARI, Potenza Picena (IT)

(21) Appl. No.: 19/112,689

(22) PCT Filed: Oct. 12, 2023
(86) PCT No.: PCT/IB2023/060282

§ 371 Date: Mar. 18, 2025

(30) Foreign Application Priority Data
Oct. 12, 2022 (IT) 102022000020991

(51) Int. Cl. F21V 21/35; F21S 8/02; F21S 8/06; F21V 23/06

(52) U.S. Cl. CPC H01R 25/142; F21V 23/06; H01R 25/14

(57) ABSTRACT

A track/adapter system, in particular for interior lighting, miniaturized and optimized to achieve a minimum level of visual impact and allow the possibility of creating curves even with a small radius.

### FIELD OF THE INVENTION

The present invention relates to the technical field of lighting apparatuses and systems and, in particular, to the technical field of lighting systems comprising tracks for installing suspension, ceiling-mounted or ceiling or wall flush built-in lighting apparatuses.

### BACKGROUND ART

Track lighting systems are an important category of lighting systems. Track lighting systems provide means for positioning and/or directing in a selectable manner the lighting of a certain environment according to contingent needs, which may be linked to the type of space to be illuminated, the type of furniture, etc.

A conventional example of a track lighting system comprises at least one electrified track and lighting apparatuses adapted to interface with said electrified tracks. The tracks support the distribution of power, in low voltage or mains voltage, and the mechanical mounting of one or more lighting apparatuses that may be arranged in a plurality of positions, usually in a continuous manner, along the extension thereof.

Once mounted, therefore, track lighting systems allow for an extreme flexibility in determining the lighting conditions of an environment and allow changes to the lighting profile to be made in a quick and easy manner. In fact, track-mounted lighting apparatuses may be removed, added, moved and replaced as needed.

The visual impact of lighting systems of this type, as a whole, comprises both the light produced—obviously—and the appearance of the track and of the lighting apparatuses, and the integration thereof with the surrounding environment, when both are mounted on a ceiling or on a wall. Even the track, therefore, as well as the lighting apparatus, is considered a furnishing element in its own right and, therefore, the more it is integrated with the environment housing it, the more pleasant it is considered.

Among the lighting apparatuses which are most often made to be installed on electrified tracks there are, for example, adjustable spotlights. Track-installation allows the advantage, as mentioned, of being able to change the anchoring position of the lighting apparatus and, in the case of adjustable spotlights, this degree of freedom is added to the possibility of varying the direction of the light beam emitted, thus reaching a complete flexibility in adapting the emissions of the light sources to the needs of the environment in which they are installed. In fact, if the item arrangement in the environment changes, the spotlights may be easily oriented or moved along the track or removed from the electrified track and mounted in another position.

There are various types of electrified tracks.

A first type consists of suspension tracks which are anchored to the ceiling by means of cables or by means of screws or metal supports. This type of tracks is frequently used, for example, in case of spaces with very high ceilings or where it is necessary, in general, to have adjustable light beams for illuminating items, walls, etc.

Another type of electrified tracks for lighting apparatuses comprises electrified tracks that are built-in, associated with plasterboard walls or ceilings and the like. Plasterboard walls are used when there is a need for flexibility in setting up environments, such as, for example, in the field of commercial establishments, where furnishings are often modified, or in the case of domestic environments where masonry works are impracticable or difficult. In this case, built-in tracks may at least partially be housed in the thickness of the plasterboard wall. Some built-in tracks may advantageously be provided with holding flaps adapted to facilitate the fastening of the track to the plasterboard wall or ceiling and also, sometimes, to perform a holding function for the panels which make up the false ceiling.

Cables and power supply, assembly, anchoring and holding systems for the installed tracks may also be arranged inside the plasterboard walls, which generally hide compartments and housings. For this reason, built-in electrified tracks generally appear smaller in size with respect to suspension ones. However, since this type of electrified track directly affects the appearance of the ceiling, in fields in which the design content of the furniture is important, the application of this type of track may encounter obstacles and may not be adopted despite being the most comfortable solution to adopt. Furthermore, the tracks currently available may only be used for straight sections and may not travel along curved sections, effectively limiting application possibilities and flexibility of use.

In consideration of the above technical issues, the owner of the present patent application has developed a new system, which may be of the suspension or built-in type, for installing electrical apparatuses, in particular lighting apparatuses, on walls and ceilings. The system comprises a track with a very small section and a corresponding adapter, also very small in size and adapted to engage with said track. The track/adapter system according to the present description allows, in particular in the case of built-in installations, to achieve a minimum level of visual impact by virtue of the almost total concealing of the track in the plasterboard wall and, in general, it allows a very high flexibility of installation by virtue of the possibility of creating curves even with a small radius.

### SUMMARY OF THE INVENTION

The system according to the present description, in particular, but not exclusively, for installing lighting apparatuses on plasterboard walls and the like, comprises an electrified track and a corresponding adapter, both miniaturized to minimize the visual impact of the electrified track and of the lighting apparatus when installed.

The track of the system according to the present description has a section comprising at least one first compartment—provided with two side housings adapted to house two metal conductors housed in supports made of insulating material, longitudinally extending for the entire length of the track—communicating with a second compartment having an opening facing towards the outside, configured to accommodate the knife connector of an adapter. Said first and second compartments are separated by the holding means of said supports made of insulating material of the metal contacts. For example, said holding means may consist of two tabs having one end anchored to the side wall of the track and the other end free, and shaped so as to exert a pressure adapted to keep the aforesaid supports made of insulating material in the correct position.

Preferred embodiments of the aforesaid track comprise different fastening means based on the particular use of the track itself. Therefore, the aforesaid track may be provided, for example, with a third compartment communicating with the outside and adapted to engage with locking elements—such as, for example, the head of a screw—for the connection to the ceiling or to the wall as a ceiling. Alternatively, a flap may be provided, integral with the upper wall of said first compartment and provided with hooking means for positioning the track in suspension mode, for example connected to the metal frame of the false ceiling.

Furthermore, said track may comprise two wings which perpendicularly extend with respect to the side walls of said second compartment and are adapted to hold the false ceiling panels arranged at the sides of the track itself, for example panels used for false ceilings provided with a metal frame.

The adapter of the lighting system according to the present description has a knife connector provided with two electrical contacts adapted to engage with the electrical conductors of the first compartment of the track and reversible mechanical locking means adapted to engage with said second compartment of the track.

In further detail, said knife connector comprises a central part joined to a base connectable to the holding arm of a lighting device, and comprising two electrical contacts connected to a connection cable towards the optical group of the lighting device, and two ends comprising reversible mechanical locking means adapted to engage with said second compartment of the track.

The reversible mechanical locking means of the two ends of the knife of the adapter preferably comprise a compressible spring having dimensions at rest which are larger than the opening of the aforesaid second compartment of the track.

Advantageously, an anti-release safety device may be provided, adapted to avoid an accidental release of the adapter from the track which houses it. An example of an anti-release safety device that may be used includes a wedge made of metal or plastic material hinged on the end of said knife connector and adapted to engage with said compressible spring so as to prevent the compression thereof and therefore the exit from the second compartment of the track when on site. Other examples of anti-release safety devices may, obviously, be used to prevent the release of the knife of the adapted.

Said electrical contacts may advantageously be obtained by means of two tabs having ends accessible from the surface of the knife connector and compressible. The ends of said tabs may be provided with convexities facing towards the outside of the adapter, on opposite sides thereof, and adapted to engage, after an appropriate compression, with the first compartment of the track in a position such as to create a stable connection with the contacts present inside said first compartment of the track.

Furthermore, the knife of said adapter comprises a casing, an outer shell, preferably made of insulating and deformable plastic material, adapted to house said reversible mechanical locking means of the two ends of the knife of the adapter and the contacts of the central part of the adapter so as to leave said compressible ends exposed. This casing, in addition to having the task of protecting and giving mechanical stability to the parts of the knife, allows the knife itself to be reversibly deformable so as to engage with both straight and curved tracks.

According to the conventional use of the invention, during the step of inserting the adapter, the knife is introduced into the compartment of the track; when the compressible spring of the two ends of the knife meets the opening of the aforesaid second compartment of the track, further pushing the adapter, the aforesaid compressible spring is compressed until it enters the opening and subsequently expands again inside the second compartment of the track, thus engaging therewith and effectively locking the knife of the adapter in place.

Correspondingly, the contacts present in the central part of the knife of the adapter also engage with the first compartment of the track so as to be pressed against the corresponding metal conductors arranged in said first compartment inside the track.

In a preferred embodiment, spring or pressure contacts may be used, suitably selected and sized based on the distance existing between the conductors integrated in the first compartment inside the track.

According to the embodiments described, in the case where the knife must curve to adapt to curved portions of the track, the central part of the knife, comprising the electrical contacts, is made so as not to undergo deformations, so as to ensure the stability of the aforesaid electrical contacts and the adhesion thereof to the corresponding conductors of the track.

According to a further embodiment of the invention, the adapter may be made with a knife provided with an extension adapted to receive electronic devices which are powered by means of cables or printed tracks connected to the aforesaid electrical contacts.

The system comprising the electrified track and the relative adapter according to the present invention allows to achieve very high levels of miniaturization. The facing contacts integrated in the adapter may be brought closer together up to the limit of the minimum distance required by the electrical safety regulations which depend on the electrical voltage applied to the contacts of the track.

### BRIEF DESCRIPTION OF THE DRAWINGS

Further features and advantages of the invention will become apparent from reading the following detailed description, given by way of a non-limiting example, with the aid of the figures shown in the accompanying drawings, in which:

FIG. 1 shows a sectional view of a preferred embodiment of the track according to the present invention;

FIG. 2 shows a sectional view of a first compartment of a preferred embodiment of the track according to the present invention;

FIG. 3 shows a sectional view of a second compartment of a preferred embodiment of the track according to the present invention;

FIG. 4 shows a sectional view of a preferred embodiment of the track according to the present invention;

FIG. 5 shows a sectional view of a preferred embodiment of the track according to the present invention;

FIG. 6 shows a perspective view of a preferred embodiment of the track according to the present invention;

FIG. 7 shows a sectional view of a preferred embodiment of the track according to the present invention;

FIG. 8 shows a perspective view of the knife of a preferred embodiment of the adapter according to the present invention;

FIG. 9 shows perspective and sectional views of the knife of a preferred embodiment of the adapter according to the present invention;

FIG. 10 shows an exploded view of the knife of a preferred embodiment of the adapter according to the present invention;

FIG. 11 shows a perspective view of a preferred embodiment of the adapter according to the present invention in which the base is connected to a lighting device and the knife is deformed so as to be curved, and

FIG. 12 shows perspective and sectional views of a preferred embodiment of the adapter according to the present invention, provided with an extension adapted to receive electronic devices.

The following description of exemplary embodiments relates to the accompanying drawings. The same reference numbers in the various drawings identify the same elements or similar elements. The following detailed description does not limit the invention. The scope of the invention is defined by the appended claims.

### DETAILED DESCRIPTION OF THE INVENTION

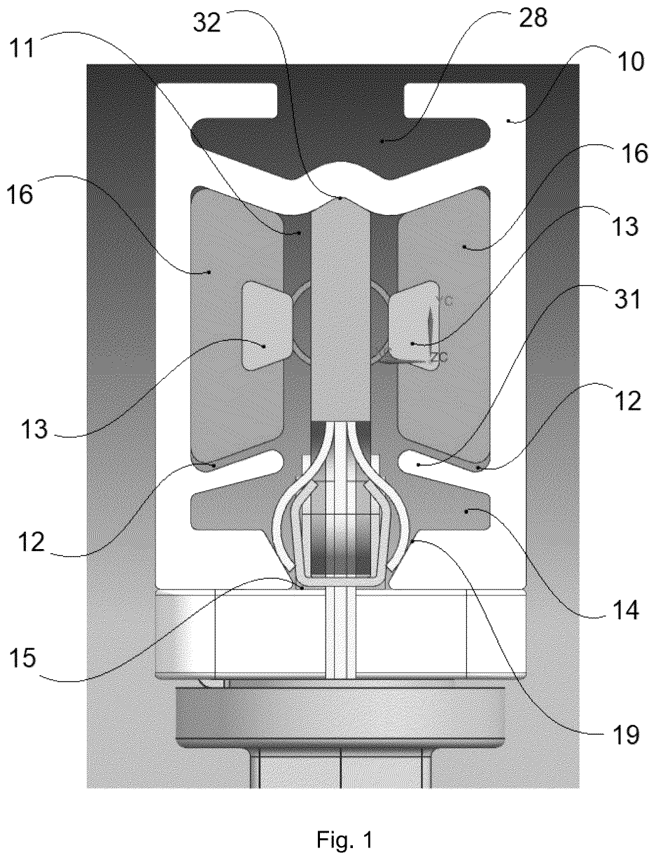

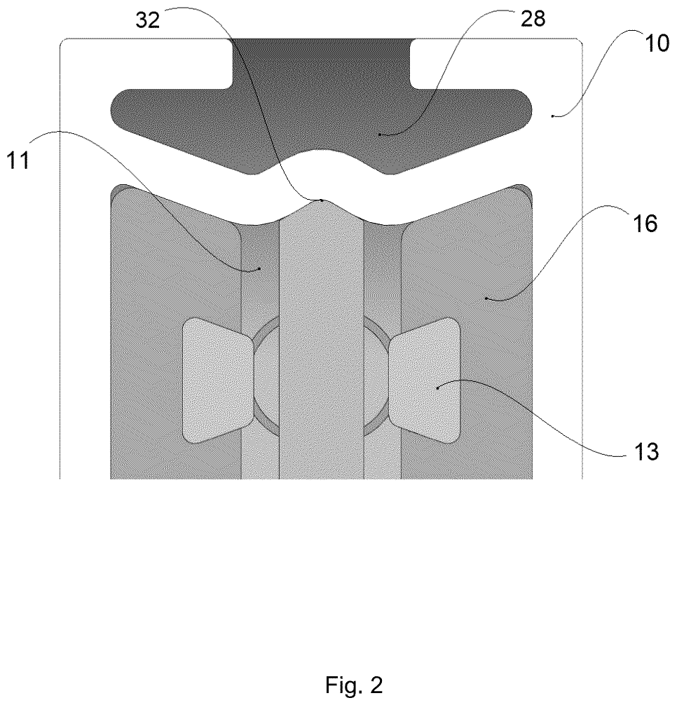

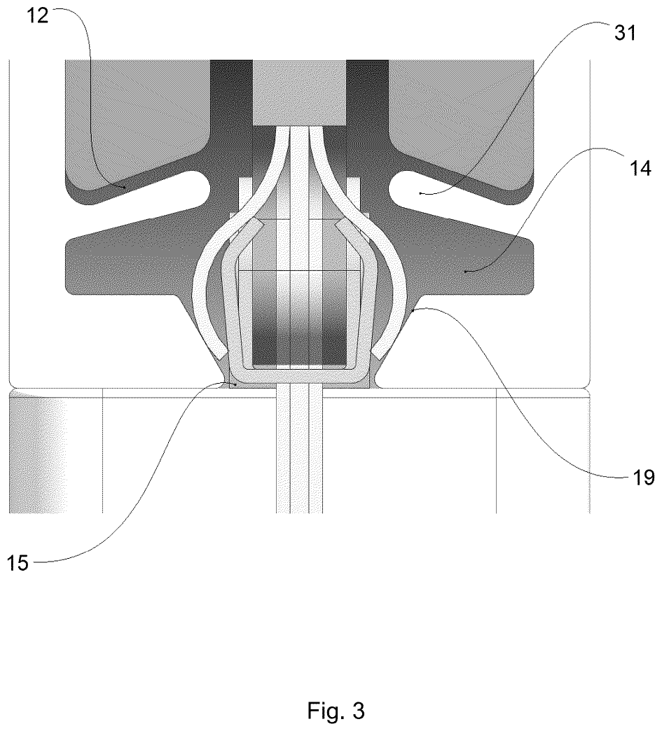

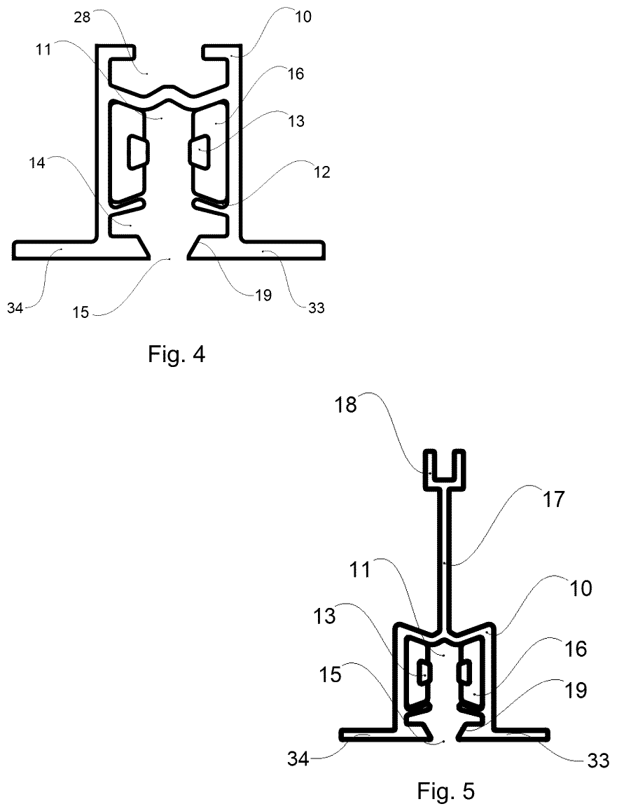

With reference to the accompanying FIGS. 1, 2 and 3, in a preferred embodiment, the track 10 of the system according to the present description has a section comprising at least one first compartment 11, provided with two side housings 12 adapted to house two electrical conductors 13 longitudinally extending for the entire length of the track, communicating with a second compartment 14, having an opening 15 facing towards the outside and adapted to receive a knife connector 21 of an adapter 20 which may be powered by means of the track 10. Preferably, said electrical conductors 13 are arranged, each, on a special support 16 made of insulating material from which they are accessible so that the mutual distance between said electrical conductors 13 complies with the safety regulations in force relating to the voltage at which said electrical contacts are subjected. Preferably, said support 16 made of insulating material is made of plastic material of a thickness sufficient to ensure the safety distance between the electrical conductors 13 and the other metal parts of the track. Preferably, the upper wall of the first compartment comprises a recess 32 adapted to house the top of the knife 21 of the adapter 20 when inserted. This recess allows to guide the knife of the adapter so that it is in the correct position, ensuring that the electrical contacts of the track and the adapter are mutually engaged in the correct manner, thus minimizing electrical contact resistance.

In a preferred embodiment, said second compartment 14 is provided with an opening 15 towards the outside—obtained in the lower wall of the track 10—having oblique sides 19, so that the end facing towards the inside of the track of said opening 15 is wider than the end facing towards the outside.

Said first compartment 11 and second compartment 14 are distinct or separate from the holding means of said supports 16 made of insulating material of the electrical conductors 13 present on the side walls of the track 10. For example, said holding means may consist of two tabs 31 having one end anchored to the side wall of the track and the other end free, and shaped so as to exert a pressure, along the entire length or in sections, adapted to keep the aforesaid supports 16 made of insulating material in the correct position in the housing 12.

Preferred embodiments of the track 10 comprise different wall fastening means based on the particular use of the track itself. Therefore, the track 10 may be provided, for example, with a third compartment 28 communicating with the outside and adapted to engage with locking elements—such as, for example, the head of a screw—for the connection to the ceiling or to the wall as a ceiling. Alternatively, a flap 17 may be provided, integral with the upper wall of said first compartment and provided with hooking means 18 for positioning the track in suspension mode, for example connected to the metal frame of the false ceiling.

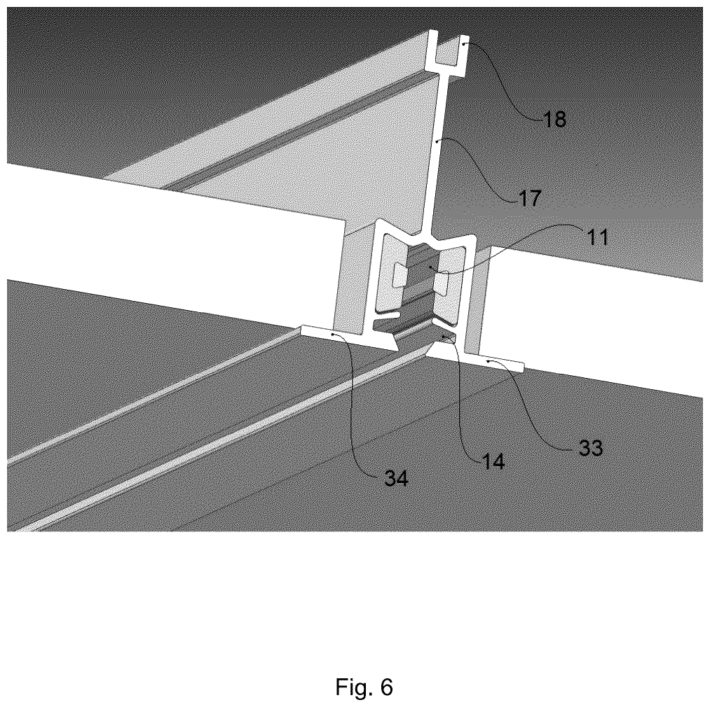

Furthermore, said track 10 may comprise two wings 33, 34 which perpendicularly extend with respect to the side walls of said second compartment 11 and are adapted to hold the false ceiling panels arranged at the sides of the track itself, for example panels used for false ceilings provided with a metal frame as shown in Figure accompanying FIG. 6.

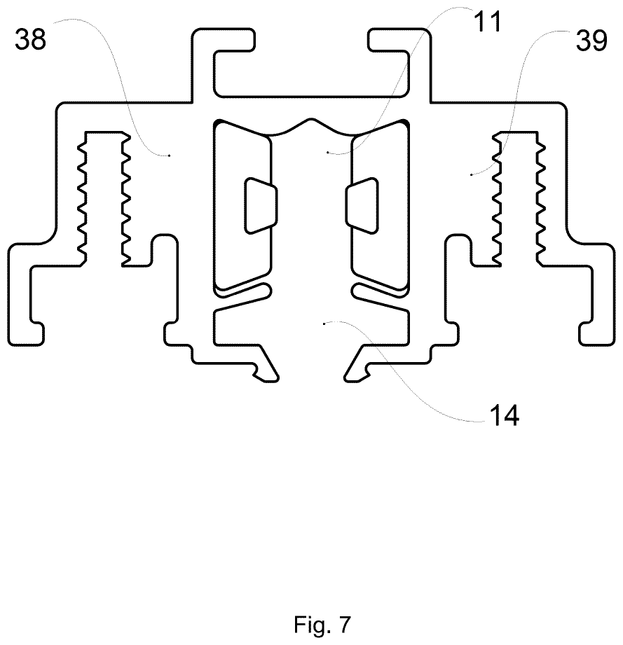

In another embodiment, shown in accompanying FIG. 7, said track 10 comprises two side legs 38, 39, integral with the side walls of said first compartment 11 and second compartment 14 adapted to house means for fastening plates, of various sizes, having the function of holding plasterboard ceilings and of assisting in the operation of grouting the plasterboard wall itself near the track. Said fastening means may advantageously comprise threaded housings for screws.

Advantageously, said track 10 may be made of both plastic and metal material.

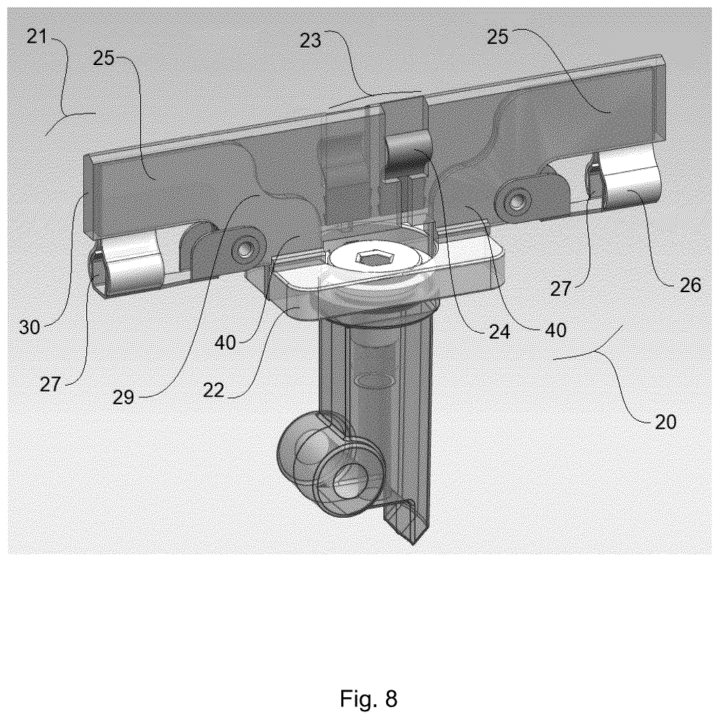

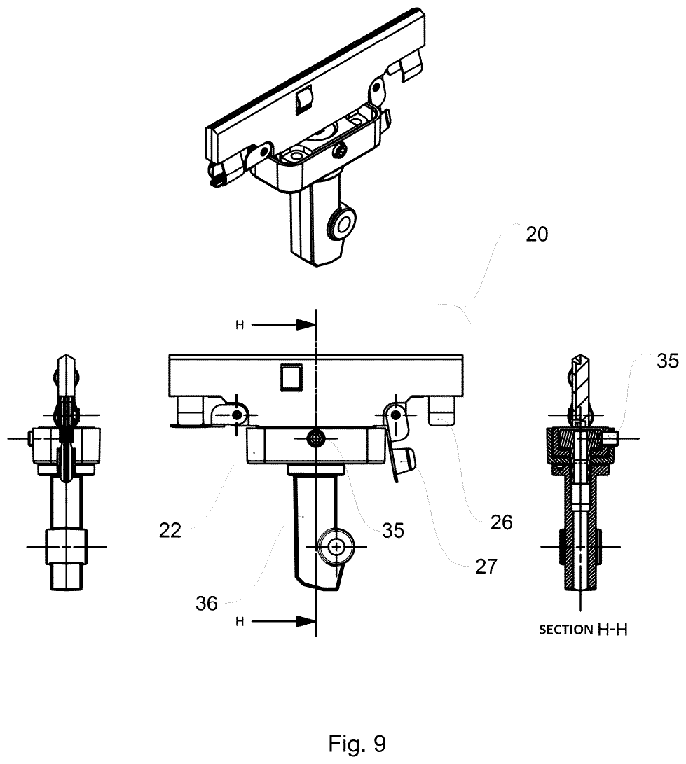

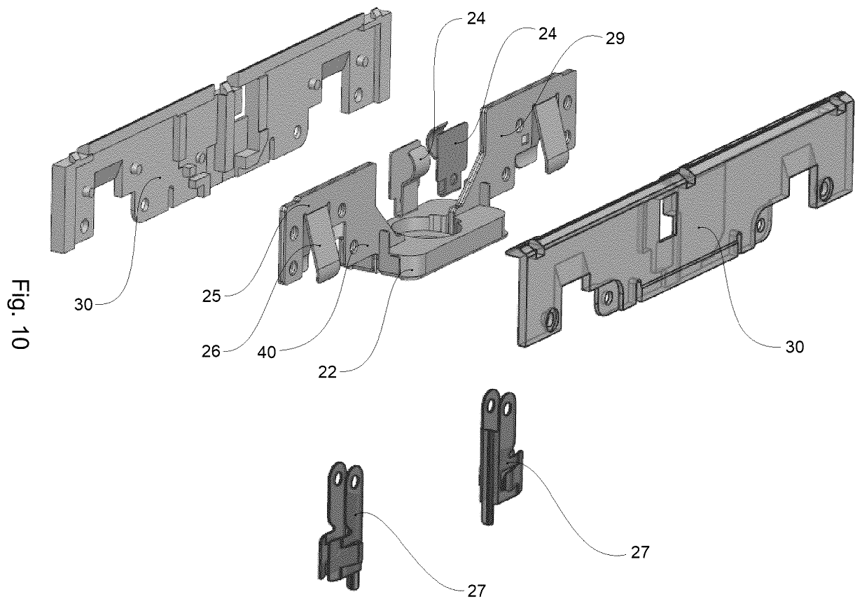

With reference to the accompanying FIG. 8, in a preferred embodiment, the adapter 20 of the system according to the present description comprises a knife connector 21 preferably connected to a base 22 which, in turn, may be connected, for example, to the holding arm 36 of a lighting device. Said base 22 may be provided with a rotation block made, for example, with a headless screw 35 adapted to engage with the mutually moving parts of the base 22, as shown in accompanying FIG. 9.

Said knife connector 21 comprises a central part 23 which in turn comprises two electrical contacts 24 which are connectable, for example, to a connection cable towards the optical group of the lighting device associated with the base 22. Said two electrical contacts 24 are adapted to engage with the electrical conductors 13 of the first compartment 11 of the track 10 and may be made, for example, with two tabs having ends accessible from the surface of the knife connector and compressible. The ends of said tabs may advantageously be provided with convexities facing towards the outside of the knife of the adapter, on opposite sides thereof, and adapted to engage, after an appropriate compression, with the first compartment 11 of the track 10 in a position such as to create a stable connection with the conductors 13 present inside said first compartment 11 of the track 10.

The knife connector 21 further comprises at least one blade 29 which is flexible and has a high degree of mechanical robustness, said at least one blade 29 having a first end 40 integral with said base 22, when present, and a second end 25 integral with reversible mechanical locking means adapted to engage with said second compartment 14 of the track 10.

The connection between the first end 40 of the blade 29 and the base 22 may be obtained by means of welding or by means of mechanical fixings such as, for example, rivets, eyelets, fasteners etc.

Said reversible mechanical locking means integral with the second end 25 of said at least one blade 29 preferably comprise a compressible spring 26 having dimensions at rest which are larger than the opening 15 of the aforesaid second compartment 14 of the track 10.

Furthermore, said blade 29 may advantageously comprise an anti-release safety device adapted to avoid the accidental release of the adapter 20 from the track 10 which houses it.

An example of an anti-release safety device which may be used includes a wedge 27, preferably made of metal material, hinged on said blade 29 and adapted to engage with said compressible spring 26 so as to prevent the compression thereof and therefore the exit from the second compartment 14 of the track when on site.

The knife 21 of said adapter 20 further comprises an outer casing 30, preferably made of deformable plastic material, adapted to house at least part of said at least one blade 29 and the electrical contacts 24 of the central part 23 of the knife 21 of the adapter 20 so as to leave the ends of said electrical contacts 24 uncovered.

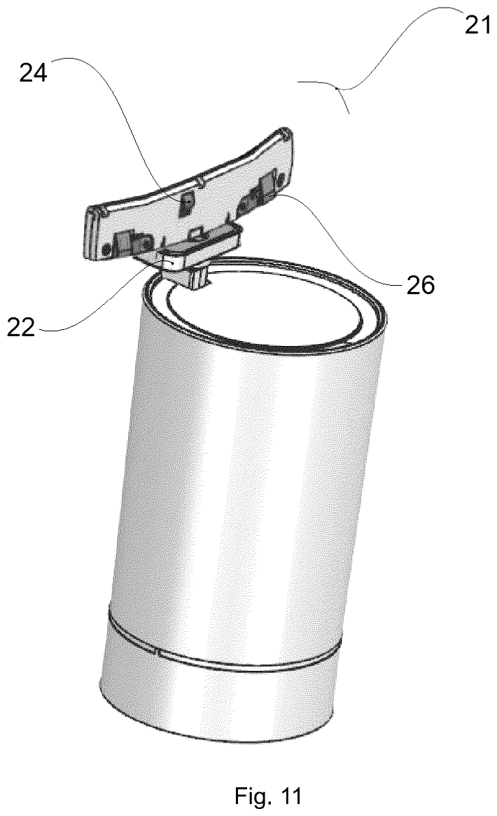

This casing 30 protects and gives mechanical stability to the various parts of the knife 21 and, together with said blades 29, allows said knife 21 to be reversibly deformable so as to advantageously engage with both straight and curved tracks. Accompanying FIG. 11 shows an example of an adapter 20 according to the present invention in which the base 22 is connected to a lighting device and the knife 21 is deformed so as to be curved.

To ensure the correct functionality and the aforesaid deformation capacity of the knife 21, said blade 29 is made with suitable materials and thicknesses. For example, said blade 29 can be made with a thicknesses approximately equal to or less than 1 mm and with metal material usually used for producing springs, such as heat-treated carbon steel, stainless steel or copper alloys, such as beryllium copper or phosphor bronze. Said casing 30 may advantageously be made of reversibly deformable plastic materials, such as polycarbonate or polyamide. Obviously, the blade 29 may be made in thicknesses greater than 1 mm, compatibly with the material used and with the degree of flexibility desired.

Furthermore, in a preferred embodiment, said blades 29 are made comprising three sandwiched facing layers, wherein the two outer layers are preferably made with thicknesses approximately equal to or less than 0.25 mm, while the inner layer is preferably made with thicknesses approximately equal to or less than 0.4 mm. All three layers may be with metal material usually used for producing springs, such as heat-treated carbon steel or copper alloys, such as beryllium copper or phosphor bronze. Obviously, the blades 29 may be made comprising a single layer or two layers, compatibly with the material used and with the degree of flexibility desired. Furthermore, said blades may be made not only of metal materials, but also of thermoplastic materials.

The use of multiple metal layers in the production of the blades 29 of the knife 21 of the adapter 20 according to the invention, allows the knife 21 to be given the necessary robustness while, at the same time, maintaining the desired degree of flexibility which would be difficult to achieve using a single thicker layer.

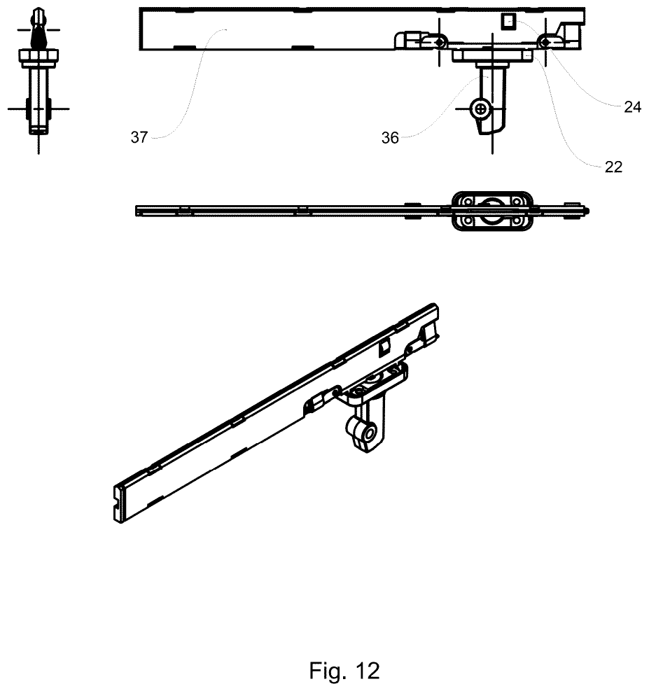

In a preferred embodiment, shown in FIG. 12, the adapter 20 according to the present description may be made with a knife 21 provided with an extension 37 adapted to receive electronic devices which are powered by means of cables or printed tracks connected to the aforesaid electrical contacts 24.

The structure of the track/adapter system according to the present invention allows to achieve particularly small dimensions. In the case of a track intended to be installed in plasterboard, said track is barely visible and, furthermore, it may be provided with a covering cap adapted to engage with the second compartment of the track itself so as to completely hide it from view.

1. A lighting track comprising at least one first compartment, provided with two side housings comprising two electrical conductors longitudinally extending for the entire length of the track; a second compartment, communicating with the first compartment, having an opening facing towards the outside and adapted to receive a knife connector of an adapter which may be electrically powered by means of the track; wall fastening means, wherein the upper wall of the first compartment comprises a recess adapted to house the top of the knife of the adapter when inserted, and wherein said second compartment is provided with an opening towards the outside having oblique sides so that the end facing towards the inside of the track of said opening has a width greater than the end facing towards the outside.

2. The lighting track of claim 1, comprising a support made of insulating material, from which said electrical conductors are accessible.

3. The lighting track of claim 1, wherein said first compartment and said second compartment are distinct or separate from the holding means of said supports made of insulating material of the electrical conductors present on the side walls of the track.

4. The lighting track of claim 3, wherein said holding means consist of two tabs having one end anchored to the side wall of the track and the other end free, and shaped so as to exert a pressure adapted to keep the aforesaid supports made of insulating material in the correct position in the housing.

5. The lighting track of claim 1, wherein said wall fastening means comprise a third compartment communicating with the outside and adapted to engage with locking elements for the connection to the ceiling or to the wall as a ceiling.

6. The lighting track of claim 1, wherein said wall fastening means comprise a flap integral with the upper wall of said first compartment and provided with hooking means for supports adapted to allow the positioning of the track in suspension mode.

7. The lighting track of claim 1, comprising two wings which perpendicularly extend with respect to the side walls of said second compartment and are adapted to hold the false ceiling panels arranged at the sides of the track.

8. An adapter for lighting tracks provided with a knife connector comprising a central part in turn comprising two electrical contacts connectable to a connection cable; at least one blade flexible and integral with mechanical reversible locking means with respect to said lighting tracks, wherein said knife is connected to a base and said at least one blade comprises a first end integral with said base and a second end integral with said mechanical reversible locking means towards said lighting tracks.

9. The adapter for lighting tracks of claim 8, wherein said reversible mechanical locking means preferably comprise a compressible spring having dimensions at rest which are larger than the opening of the second compartment of the track.

10. The adapter for lighting tracks of claim 8, wherein said at least one blade comprises an anti-release safety device for preventing the release of the adapter from the track.

11. The adapter for lighting tracks of claim 8, wherein said anti-release safety device comprises a wedge hinged on said blade and adapted to engage with said compressible spring so as to prevent the compression thereof.

12. The adapter for lighting tracks of claim 8, wherein the knife further comprises an outer casing adapted to house at least part of said at least one blade and the electrical contacts of the central part of the knife so as to leave the ends of said electrical contacts uncovered.

13. The adapter for lighting tracks of claim 8, wherein said at least one blade has a thickness approximately equal to or less than 1 mm and is made of heat-treated carbon steel or of copper alloys such as beryllium copper or phosphor bronze.

14. The adapter for lighting tracks of claim 13, wherein said at least one blade comprises three sandwiched facing layers, wherein the two outer layers are preferably made with thicknesses approximately equal to or less than 0.25 mm, while the inner layer is preferably made with thicknesses approximately equal to or less than 0.4 mm.

15. The adapter for lighting tracks of claim 8, wherein said base is in turn connectable to the holding arm of a lighting device.

16. The adapter for lighting tracks of claim 15, wherein said first end and said second end are spaced apart so as to allow a bending of said blade such as to allow the insertion of the adapter on curved tracks.

17. The adapter for lighting tracks of claim 8, wherein said knife is provided with an extension comprising a compartment adapted to receive electronic devices which may be powered by means of cables or printed tracks connected to said electrical contacts

18. The track lighting system comprising the lighting track of claim 1 and the adapter of claim 8.
